(19) United States
(12) Patent Application Publication
(10) Pub. No.: US 2023/0250255 A1
(43) Pub. Date: Aug. 10, 2023

(54) THERMOPLASTIC RESIN COMPOSITION AND MEMBER, AND METHOD OF MANUFACTURING MEMBER FORMED FROM THERMOPLASTIC RESIN COMPOSITION AND METHOD OF ENHANCING MECHANICAL STRENGTH

(71) Applicant: Polyplastics Co., Ltd., Tokyo (JP)

(72) Inventors: Yuuki Kanda, Fuji-shi, Shizuoka (JP); Hidekazu Idei, Fuji-shi, Shizuoka (JP)

(73) Assignee: Polyplastics Co., Ltd., Tokyo (JP)

(21) Appl. No.: 18/014,894

(22) PCT Filed: Jun. 14, 2021
(86) PCT No.: PCT/JP2021/022498

§ 371 Date: Jan. 6, 2023

(30) Foreign Application Priority Data
Jul. 10, 2020 (JP) 2020-119063

(51) Int. Cl. C08K 3/04; C08L 29/14; C08L 81/04; C08G 63/183; B29C 48/40; B29C 48/00; B29C 45/00

(52) U.S. Cl. CPC C08K 3/041; B29C 45/0001; B29C 48/022; B29C 48/40; C08G 63/183; C08L 29/14; C08L 81/04; B29K 2059/00; C08K 2201/011; C08L 2203/30; C08L 2205/24

(57) ABSTRACT

Provided is a thermoplastic resin composition obtained by melt-kneading at least 0.1 to 0.5 parts by mass of a carbon nanostructure relative to 100 parts by mass of a thermoplastic resin; a member formed by molding the thermoplastic resin composition; a method of manufacturing a member including steps of preparing the thermoplastic resin composition, and molding the thermoplastic resin composition into a predetermined shape; and a method of enhancing mechanical strength of a member formed from a thermoplastic resin composition by using a resin composition obtained by melt-kneading 0.1 to 0.5 parts by mass of a carbon nanostructure relative to 100 parts by mass of a thermoplastic resin.

### TECHNICAL FIELD

The present invention relates to a thermoplastic resin composition and a member formed from the thermoplastic resin composition, and a method of manufacturing the member and a method of enhancing mechanical strength.

### BACKGROUND ART

Thermoplastic resins such as polyacetal resins, polyarylene sulfide resins, polybutylene terephthalate resins, polyethylene terephthalate resins, and polyamide resins are excellent in physical and mechanical properties, chemical resistance, and the like. Therefore, such thermoplastic resins are widely used as engineering plastics. Various additives are generally added to the thermoplastic resins for the purpose of improving performance such as mechanical properties (see Patent Literature 1). As such additives, there are various fillers including fibrous fillers such as glass fibers, plate-like fillers such as glass flakes and talc, and spherical fillers such as glass beads.

### CITATION LIST

### Patent Literature

[Patent Literature 1] Japanese Unexamined Patent Application Publication No. 2008-144002

### SUMMARY OF THE INVENTION

### Problem to Be Solved by the Invention

However, if the mechanical strength and elastic modulus are to be improved by adding a filler as described above, it is necessary to add a certain amount or more of a filler to the thermoplastic resin. If a certain amount or more of a filler is added, the tensile elongation at break and impact resistance will decrease.

The present invention has been devised in view of the above problems in the past, and an object of the present invention is to provide a thermoplastic resin composition and a member formed from the thermoplastic resin composition, and a method of manufacturing the member and a method of enhancing mechanical strength, which are capable of enhancing mechanical properties without significantly impairing tensile elongation at break and impact resistance.

### Means for Solving the Problem

The present invention was devised based on the finding that it is possible to enhance mechanical strength without significantly impairing tensile elongation at break and impact resistance merely by adding a trace amount of a carbon nanostructure to a thermoplastic resin.

One aspect of the present invention to solve the above problems is as follows.
(1) A thermoplastic resin composition obtained by melt-kneading at least 0.1 to 0.5 parts by mass of a carbon nanostructure relative to 100 parts by mass of a thermoplastic resin.
(2) The thermoplastic resin composition according to (1) above, in which the thermoplastic resin is one type selected from the group consisting of a polyacetal resin, a polyarylene sulfide resin, a polybutylene terephthalate resin, a polyethylene terephthalate resin, and a polyamide resin.
(3) A member formed by molding the thermoplastic resin composition according to (1) or (2) above.
(4) A method of manufacturing a member including steps of: preparing a thermoplastic resin composition obtained by melt-kneading at least 0.1 to 0.5 parts by mass of a carbon nanostructure relative to 100 parts by mass of a thermoplastic resin; and molding the thermoplastic resin composition into a predetermined shape.
(5) A method of enhancing mechanical strength of a member formed from a thermoplastic resin composition by using a resin composition obtained by melt-kneading 0.1 to 0.5 parts by mass of a carbon nanostructure relative to 100 parts by mass of a thermoplastic resin.

### Effect of the Invention

According to the present invention, it is possible to provide a thermoplastic resin composition and a member formed from the thermoplastic resin composition, and a method of manufacturing the member and a method of enhancing mechanical strength, which are capable of enhancing mechanical properties without significantly impairing tensile elongation at break and impact resistance.

### MODES FOR CARRYING OUT THE INVENTION

### Thermoplastic Resin Composition

A thermoplastic resin composition of the present embodiment is obtained by melt-kneading at least 0.1 to 0.5 parts by mass of a carbon nanostructure (hereinafter also referred to as “CNS”) to 100 parts by mass of a thermoplastic resin.

Each component of the thermoplastic resin composition of the present embodiment will be described below.

### Thermoplastic Resin

In the present embodiment, examples of the thermoplastic resin includes a crystalline thermoplastic resin, such as a polyacetal resin (hereinafter also referred to as a “POM resin”), a polyarylene sulfide resin (hereinafter also referred to as a “PAS resin”), a polybutylene terephthalate resin (hereinafter also referred to as a “PBT resin”), a polyethylene terephthalate resin, a polyamide resin, or the like.

Among the above, the thermoplastic resin is preferably one selected from the group consisting of a polyacetal resin, a polyarylene sulfide resin, a polybutylene terephthalate resin, a polyethylene terephthalate resin, and a polyamide resin. The thermoplastic resin will be described below by taking a POM resin, PAS resin, and PBT resin as examples, but in the present embodiment, the thermoplastic resin is not limited to those resins.

### Polyacetal Resin (POM Resin)

A POM resin is a polymer compound having an oxymethylene group (—CH₂O—) as a main constituent unit, and may be either a polyacetal homopolymer or a polyacetal copolymer. The polyacetal copolymer has an oxymethylene group as a main repeating unit. In addition to an oxymethylene group, the polyacetal copolymer also contains other constituent units, for example contains a small amount of a comonomer unit such as ethylene oxide, 1,3-dioxolane, or 1,4-butanediol formal. In addition to the above polymers, the resin may be either a terpolymer or a block polymer. The POM resin may have branching and crosslinked structures as well as linear molecules. The POM resin may be a known modified polyacetal resin in which another organic group is introduced. In addition, there is no particular restriction regarding the degree of polymerization of the POM resin. It is sufficient if the POM resin has melt molding processability (for example, if a melt flow rate (MFR) measured at 190° C. and a load of 2160 g in accordance with ISO 1133 is 1.0 g/10 min or more and 100 g/10 min or less).

The POM resin is manufactured by means of a known manufacturing method.

### Polybutylene Terephthalate Resin (PBT Resin)

The PBT resin is obtained by means of polycondensation of a dicarboxylic acid component and a glycol component. The dicarboxylic acid component contains at least terephthalic acid or an ester-forming derivative thereof (C1-6 alkyl ester, acid halide, or the like). The glycol component contains at least alkylene glycol with 4 carbon atoms (1,4-butanediol) or an ester-forming derivative thereof (an acetylation product or the like). The PBT resin is not limited to homopolybutylene terephthalate, and may be a copolymer containing 60 mol% or more (especially 75 mol% or more and 95 mol% or less) of butylene terephthalate units.

The terminal carboxyl group amount of the PBT resin is not particularly limited as long as the effect of the thermoplastic resin of the present embodiment is not inhibited. The terminal carboxyl group amount of the PBT resin is preferably 30 meq/kg or less, and more preferably 25 meq/kg or less.

The intrinsic viscosity (IV) of the PBT resin is preferably 0.65 to 1.20 dL/g. If a PBT resin having an intrinsic viscosity in this range is used, the resulting resin composition is particularly excellent in mechanical properties and fluidity. Conversely, if the intrinsic viscosity is less than 0.65 dL/g, excellent mechanical properties may not be obtained, and if the intrinsic viscosity is more than 1.20 dL/g, excellent fluidity may not be obtained.

A PBT resin having an intrinsic viscosity in the above range can also be blended with a PBT resin having a different intrinsic viscosity to adjust the intrinsic viscosity. By blending a PBT resin having an intrinsic viscosity of 0.9 dL/g with a PBT resin having an intrinsic viscosity of 0.7 dL/g, it is possible to prepare a PBT resin having an intrinsic viscosity of 0.8 dL/g, for example. The intrinsic viscosity (IV) of a PBT resin can be measured in o-chlorophenol at a temperature of 35° C., for example.

In the PBT resin, examples of dicarboxylic acid components (comonomer components) other than terephthalic acid and its ester-forming derivatives include C8-14 aromatic dicarboxylic acids such as isophthalic acid, phthalic acid, 2,6-naphthalenedicarboxylic acid, and 4,4′-dicarboxydiphenyl ether; C4-16 alkanedicarboxylic acids such as succinic acid, adipic acid, azelaic acid, and sebacic acid; C5-10 cycloalkanedicarboxylic acid such as cyclohexane dicarboxylic acid; and ester-forming derivatives of these dicarboxylic acid components (C1-6 alkyl ester derivatives, acid halides, and the like). These dicarboxylic acid components can be used alone or a combination of two or more can be used.

Among these dicarboxylic acid components, the following are more preferable: C8-12 aromatic dicarboxylic acids such as isophthalic acid, and C6-12 alkanedicarboxylic acids such as adipic acid, azelaic acid, and sebacic acid.

In the PBT resin, examples of glycol components (comonomer components) other than 1,4-butanediol include C2-10 alkylene glycols such as ethylene glycol, propylene glycol, trimethylene glycol, 1,3-butylene glycol, hexamethylene glycol, neopentyl glycol, and 1,3-octanediol; polyoxyalkylene glycols such as diethylene glycol, triethylene glycol, and dipropylene glycol; alicyclic diols such as cyclohexanedimethanol and hydrogenated bisphenol A; aromatic diols such as bisphenol A and 4,4′-dihydroxybiphenyl; C2-4 alkylene oxide adducts of bisphenol A such as an ethylene oxide 2-mol adduct of bisphenol A and a propylene oxide 3-mol adduct of bisphenol A; or ester-forming derivatives (acetylation products, or the like) of these glycols. These glycol components can be used alone or a combination of two or more can be used.

Among these glycol components, the following are more preferable: C2-6 alkylene glycols such as ethylene glycol and trimethylene glycol; polyoxyalkylene glycols such as diethylene glycol; and alicyclic diols such as cyclohexanedimethanol.

In addition to the dicarboxylic acid components and the glycol components, examples of other usable comonomer components include aromatic hydroxycarboxylic acids such as 4-hydroxybenzoic acid, 3-hydroxybenzoic acid, 6-hydroxy-2-naphthoic acid, and 4-carboxy-4′-hydroxybiphenyl; aliphatic hydroxycarboxylic acids such as glycolic acid and hydroxycaproic acid; C3-12 lactones such as propiolactone, butyrolactone, valerolactone, and caprolactone (epsilon-caprolactone, or the like); and ester-forming derivatives of these comonomer components (C1-6 alkyl ester derivatives, acid halides, acetylation products, and the like).

### Polyarylene Sulfide Resin (PAS Resin)

A PAS resin has excellent mechanical properties, electrical properties, heat resistance, and other physical and chemical properties, as well as good processability.

A PAS resin is a high polymer compound composed mainly of —(Ar—S)— (where Ar represents an arylene group) as a repeating unit. In the present embodiment, it is possible to use a PAS resin having a generally known molecular structure.

Examples of the arylene group include a p-phenylene group, an m-phenylene group, an o-phenylene group, a substituted phenylene group, a p,p′-diphenylene sulfone group, a p,p′-biphenylene group, a p,p′-diphenylene ether group, a p,p′-diphenylene carbonyl group, a naphthalene group, and the like. The PAS resin may be a homopolymer consisting only of the above repeating unit. There are cases where a copolymer containing the following heterologous repeating unit is preferable in terms of processability, and the like.

A preferably used homopolymer is a polyphenylene sulfide resin (hereinafter also referred to as a “PPS resin”) having, as a repeating unit, a p-phenylene sulfide group in which a p-phenylene group is used as an arylene group. Further, as the copolymer, the combination of two or more arylene sulfide groups composed of the arylene group can be used. Thereamong, the combination of a p-phenylene sulfide group and an m-phenylene sulfide group is particularly preferably used. Among them, one containing 70 mol% or more, preferably 80 mol% or more, of the p-phenylene sulfide group is suitable from the viewpoint of physical properties such as heat resistance, moldability, and mechanical properties. Further, among these PAS resins, a high molecular weight polymer with a substantially linear structure obtained by means of condensation polymerization from a monomer consisting mainly of a bifunctional halogen aromatic compound can be particularly preferably used. The PAS resin used in the present embodiment may be a mixture of two or more PAS resins with different molecular weights.

In addition to the PAS resin having the linear structure, examples also include the following: a polymer in which, during condensation polymerization, a small amount of a monomer such as a polyhaloaromatic compound having three or more halogen substituents is used to form a branching or crosslinked structure partially; and a polymer in which a low-molecular weight polymer having a linear structure is heated at a high temperature in the presence of oxygen or the like and melt viscosity is increased by means of oxidative crosslinking or thermal crosslinking to enhance the molding processability.

The melt viscosity of the PAS resin as a base resin used in the present embodiment (310° C., a shear rate of 1200 sec⁻¹) is preferably 5 to 500 Pa • s including the case of the above mixed system.

### Carbon Nanostructure (CNS)

In the thermoplastic resin composition of the present embodiment, a predetermined amount of a CNS is added to the thermoplastic resin and the mechanical properties are enhanced due to the nucleating-agent effect of the CNS. More specifically, it can be considered that the CNS functions as a nucleating agent by adding a predetermined amount of the CNS to the thermoplastic resin, and the mechanical properties can be enhanced due to the nucleating-agent effect. Moreover, since a small amount of a CNS exhibits the nucleating-agent effect, the mechanical strength can be enhanced by using the above described small amount of a CNS. In the present embodiment, a “nucleating agent” is synonymous with a “crystal nucleating agent”, a “nucleation agent”, and the like.

The CNS used in the present embodiment is a structure containing a plurality of carbon nanotubes in a bonded state. A carbon nanotube is bonded to other carbon nanotubes by a branching or crosslinked structure. Details of such CNSs are disclosed in U.S. Pat. Application Publication No. 2013-0071565, U.S. Pat. No. 9,113,031, U.S. Pat. No. 9,447,259, and U.S. Pat. No. 9,111,658.

The CNS used in the present embodiment may be a commercial product. ATHLOS 200, ATHLOS 100, and the like manufactured by Cabot Corporation can be used, for example.

There is no particular limitation for the method of adding CNS to the thermoplastic resin in the thermoplastic resin composition of the present embodiment, and the addition can be performed by means of a conventionally known method.

In the thermoplastic resin composition of the present embodiment, the content of the CNS relative to 100 parts by mass of thermoplastic resin is 0.1 to 0.5 parts by mass. If the CNS content is less than 0.1 parts by mass, the mechanical strength is inferior. If the content is more than 0.5 parts by mass, the tensile elongation at break is greatly reduced. The CNS content is preferably 0.1 to 0.4 parts by mass, and more preferably 0.1 to 0.3 parts by mass.

In the present embodiment, a nucleating agent may be used in combination as long as the effect is not inhibited. Examples of the nucleating agent include carbon black, calcium carbonate, mica, talc, kaolin, titanium oxide, alumina, calcium silicate, boron nitride, ammonium chloride, and the like.

### Other Components

Various stabilizers selected as needed may be blended in the thermoplastic resin composition of the present embodiment. Examples of the stabilizers used here include any one or more of a hindered phenolic compound, a nitrogen-containing compound, a hydroxide of an alkali or alkaline earth metal, an inorganic salt, a carboxylate, and the like. In addition, as long as the above effect is not inhibited, one or more of the following can be added to the thermoplastic resin as common additives when needed: a coloring agent such as a dye or a pigment, a lubricant, a mold release agent, an antistatic agent, a surfactant, a flame retardant, an organic polymer material, and an inorganic or organic fibrous, powdery, or plate-like filler.

There is no particular limitation for the method of fabricating a molded article by using the thermoplastic resin composition of the present embodiment, and a known method can be adopted. The thermoplastic resin composition of the present embodiment can be put into an extruder, and then melt-kneaded and pelletized, for example. The thus obtained pellets can be put into an injection-molding machine having a predetermined mold and a molded article can be fabricated by performing injection-molding.

### Member

A member of the present embodiment is formed by molding the thermoplastic resin composition of the present embodiment described above. Therefore, the member of the present embodiment has high mechanical strength similar to the thermoplastic resin composition of the present embodiment.

The member of the present embodiment can be widely applied to usage applications for which a thermoplastic resin composition is used. The member can be suitably used for automotive parts such as fuel piping parts and electric and electronic parts such as printer parts, for example. However, the above usage examples are merely examples and the usage purpose of the member is not limited thereto.

### Manufacturing Method of Member

A manufacturing method of the member according to the present embodiment includes a step of preparing a thermoplastic resin composition obtained by melt-kneading at least 0.1 to 0.5 parts by mass of a carbon nanostructure relative to 100 parts by mass of a thermoplastic resin (hereinafter referred to as “step A”) and a step of molding the thermoplastic resin composition into a predetermined shape (hereinafter referred to as “step B”).

Each step will be described below.

### Step A

In step A, a thermoplastic resin composition is prepared, which is fabricated by melt-kneading at least 0.1 to 0.5 parts by mass of a carbon nanostructure to 100 parts by mass of a thermoplastic resin. The preferred components for each component in the thermoplastic resin composition, the preferred content thereof, and other components are as described above. The thermoplastic resin composition is obtained by melt-kneading each component described above with other components as needed according to a normal method. It is possible to obtain pellets by putting the thermoplastic resin composition of the present embodiment into an extruder, and then melt-kneading and pelletizing the composition, for example. The CNS is prepared as a masterbatch, and this masterbatch may be used when the CNS is added. The masterbatch is a thermoplastic resin composition which is fabricated in advance and contains a high concentration of the CNS.

### Step B

In step B, the thermoplastic resin composition is molded into a predetermined shape. The pellets obtained as described above are put into an injection-molding machine having a predetermined mold and are injection-molded.

By means of the manufacturing method of the present embodiment described above, it is possible to manufacture a member having sufficient mechanical strength as described above.

### Method of Enhancing Mechanical Strength of Member Formed From Thermoplastic Resin Composition

In the method of enhancing the mechanical strength of the member formed from the thermoplastic resin composition according to the present embodiment, a resin composition is used which is obtained by melt-kneading 0.1 to 0.5 parts by mass of a carbon nanostructure relative to 100 parts by mass of a thermoplastic resin.

As described above, in the thermoplastic resin composition of the present embodiment, by adding a predetermined amount of the CNS to the resin, the nucleating-agent effect is exhibited and mechanical strength can be enhanced. That is, by using the thermoplastic resin composition of the present embodiment as the member, the mechanical strength of the member can be enhanced. In the method of enhancing the mechanical strength of the member formed from the thermoplastic resin composition of the present embodiment, the thermoplastic resin, preferred content of the CNS, and other components are the same as those described above for the thermoplastic resin composition of the present embodiment.

### EXAMPLES

Although the present embodiment will be described more specifically by using the following examples, the present embodiment is not limited to the following examples.

### Examples 1 to 5 and Comparative Examples 1 to 8

In each example and comparative example, each raw material component (except glass fibers) shown in Tables 1 and 2 was dryblended, then put into a twin-screw extruder (glass fibers were added from a side-feeding section), and melt-kneaded and pelletized. The cylinder temperatures of the twin-screw extruder were 200° C. for a POM resin, 320° C. for a PPS resin, and 260° C. for a PBT resin. In Tables 1 and 2, numerical values of each component indicate parts by mass.

Details of each raw material component used are shown below.

### Thermoplastic Resin

### Polyacetal Resin

Polyacetal resin; polyacetal copolymer formed by copolymerizing 96.7 mass% of trioxane and 3.3 mass% of 1,3-dioxolane (melt flow rate (MFR) (measured in accordance with ISO 1133 at 190° C. with a load of 2160 g): 9.0 g/10 min)

### Polyphenylene Sulfide Resin

Manufactured by KUREHA CORPORATION, Fortron KPS (melt viscosity: 130 Pa • s (shear rate of 1200 sec⁻¹, 310° C.))

### Measurement of Melt Viscosity of PPS Resin

The melt viscosity of the above PPS resin was measured as follows.

The melt viscosity was measured at a barrel temperature of 310° C. and a shear rate of 1200 sec⁻¹ by using a flat die with an aperture diameter of 1 mm and a length of 20 mm as a capillary and a capilograph manufactured by Toyo Seiki Seisaku-sho, Ltd.

### Polybutylene Terephthalate Resin

Polybutylene terephthalate resin manufactured by Polyplastics Co., Ltd. (intrinsic viscosity (measured in o-chlorophenol at a temperature of 35° C.) : 1.0 dL/g)

### Carbon Nanostructure (CNS)

Manufactured by Cabot Corporation, ATHLOS 200

### Nucleating Agent

### Boron Nitride

Manufactured by Denka Company Limited, DENKA BORON NITRIDE GP

### Filler

Talc Crown talc PP, manufactured by Matsumura Sangyo Co., Ltd.
Glass beads EGB 731 manufactured by Potters-Ballotini Co., Ltd.
Glass fiber 1 ECS03T-651G, manufactured by Nippon Electric Glass Co., Ltd.
Glass fiber 2 Chopped strands, manufactured by OWENS CORNING JAPAN LLC. Fiber diameter: 10.5 µm, length: 3 mm

TABLE 1

| | | Example 1 | Example 2 | Example 3 | Example 4 | Example 5 |
|---|---|---|---|---|---|---|
| Thermoplastic resin | POM resin | 100 | 100 | 100 | - | - |
| | PPS resin | - | - | - | 100 | - |
| | PBT resin | - | - | - | - | 100 |
| Carbon nanostructure | | 0.1 | 0.25 | 0.5 | 0.5 | 0.5 |
| Filler | Glass fiber 2 | - | - | - | 67 | - |
| Tensile strength | MPa | 68 | 68 | 68 | 209 | 61 |
| Tensile elongation at break | % | 20.8 | 19.5 | 16.3 | 1.8 | 32.9 |
| Bending modulus | MPa | 2980 | 3080 | 3190 | 14600 | 2680 |
| Impact resistance | kJ/m² | 6.5 | 6.8 | 6.1 | - | 5.0 |

TABLE 2

| | | Comparative Example 1 | Comparative Example 2 | Comparative Example 3 | Comparative Example 4 | Comparative Example 5 | Comparative Example 6 | Comparative Example 7 | Comparative Example 8 |
|---|---|---|---|---|---|---|---|---|---|
| Thermoplastic resin | POM resin | 100 | 100 | 100 | 100 | 100 | - | - | - |
| | PPS resin | - | - | - | - | - | 100 | - | - |
| | PBT resin | - | - | - | - | - | - | 100 | 100 |
| Carbon nanostructure | | - | 1 | - | - | - | - | - | - |
| Nucleating agent | Boron nitride | - | - | - | - | - | - | - | 0.01 |
| Filler | Tale | - | - | 5 | - | - | - | - | - |
| | Glass bead | - | - | - | 11 | - | - | - | - |
| | Glass fiber 1 | - | - | - | - | 5 | - | - | - |
| | Glass fiber 2 | - | - | - | - | - | 67 | - | - |
| Tensile strength | MPa | 62 | 70 | 88 | 60 | 75 | 200 | 56 | 60 |
| Tensile elongation at break | % | 35.0 | 12.1 | 4.6 | 15.0 | 8.0 | 1.9 | 108.0 | 39.0 |
| Bending modulus | MPa | 2500 | 3420 | 3105 | 3000 | 3050 | 13800 | 2420 | 2630 |
| Impact resistance | kJ/m² | 6.0 | 6.3 | 5.0 | 4.0 | 4.0 | - | 4.1 | 3.4 |

### Evaluation

Multipurpose test pieces and strip-shaped test pieces described in ISO 294-1 were molded by means of injection-molding under the following conditions and used for the following evaluations.
POM resin composition
   Molding machine: TOSHIBA MACHINE CO., LTD., EC40
   Molding was performed in accordance with ISO 9988-1,2.
PBT resin composition
   Molding machine: TOSHIBA MACHINE CO., LTD., EC40
   Cylinder temperature: 260° C.
   Mold temperature: 80° C.
PPS resin composition
   Molding machine: manufactured by Japan Steel Works, LTD., JSW J55AD-60H-USM
   Cylinder temperature: 320° C.
   Mold temperature: 150° C.

### Tensile Strength

The tensile strength was measured in accordance with ISO 527-1,2 by using the test pieces obtained as described above. The measurement results are shown in Tables 1 and 2.

### Tensile Elongation at Break

The tensile elongation at break was measured in accordance with ISO 527-1,2 by using the test pieces obtained as described above. The measurement results are shown in Tables 1 and 2.

### Bending Modulus

The bending modulus was measured in accordance with ISO 179 by using the test pieces obtained as described above. The measurement results are shown in Tables 1 and 2.

### Impact Resistance (Charpy Impact Strength)

Charpy impact strength (with a notch) was measured in accordance with ISO 179/1eA by using the test pieces obtained as described above. The measurement results are shown in Tables 1 and 2.

From Table 1, it can be observed that all evaluations were favorable in Examples 1 to 5. That is, in Examples 1 to 5, it was possible to enhance mechanical properties without significantly impairing tensile elongation at break and impact resistance. The details are as follows. That is, when comparing Examples 1 to 3 using the POM resin with Comparative Examples 1 to 5, Comparative Example 1 without the CNS was inferior to Examples 1 to 3 in terms of tensile strength and flexural modulus. Comparative Example 2, in which the CNS content relative to 100 parts by mass of the thermoplastic resin was 1 part by mass, was inferior to Examples 1 to 3 in terms of tensile elongation at break. In particular, Comparative Example 2 shows a more remarkable decrease in tensile elongation at break from Comparative Example 1 without the CNS compared to Examples 1 to 3. Meanwhile, in Comparative Examples 3 to 5, in which the CNS was not included and a common filler was added, impact resistance was inferior.

Comparing Example 4 using the PPS resin with Comparative Example 6, Example 4 showed enhanced tensile strength and flexural modulus with little reduction in tensile elongation at break.

Comparing Example 5 using the PBT resin with Comparative Example 7 without the CNS, Example 5 shows enhanced tensile strength and flexural modulus without decreasing impact resistance. Similarly, comparing Example 5 with Comparative Example 8 using a nucleating agent, Comparative Example 8 is inferior to Example 5 in terms of impact resistance.

1. A thermoplastic resin composition obtained by melt-kneading at least 0.1 to 0.5 parts by mass of a carbon nanostructure relative to 100 parts by mass of a thermoplastic resin.

2. The thermoplastic resin composition according to claim 1, wherein
the thermoplastic resin is one type selected from the group consisting of a polyacetal resin, a polyarylene sulfide resin, a polybutylene terephthalate resin, a polyethylene terephthalate resin, and a polyamide resin.

3. A member formed by molding the thermoplastic resin composition according to claim 1.

4. A method of manufacturing a member comprising steps of:
preparing a thermoplastic resin composition obtained by melt-kneading at least 0.1 to 0.5 parts by mass of a carbon nanostructure relative to 100 parts by mass of a thermoplastic resin; and
molding the thermoplastic resin composition into a predetermined shape.

5. A method of enhancing mechanical strength of a member formed from a thermoplastic resin composition by using a resin composition obtained by melt-kneading 0.1 to 0.5 parts by mass of a carbon nanostructure relative to 100 parts by mass of a thermoplastic resin.
